(19) United States
(12) Patent Application Publication
(10) Pub. No.: US 2017/0302612 A1
(43) Pub. Date: Oct. 19, 2017

(54) SYSTEM OF QUOTA-CANCEL TASKING/MESSAGING

(71) Applicants: Steve Biddick, Cottingham (UK); Mary Patricia Biddick, Cottingham (UK); Nigel Coyle, Cottingham (UK)

(72) Inventors: Steve Biddick, Cottingham (UK); Mary Patricia Biddick, Cottingham (UK); Nigel Coyle, Cottingham (UK)

(21) Appl. No.: 15/482,905

(22) Filed: Apr. 10, 2017

Related U.S. Application Data
(60) Provisional application No. 62/323,710, filed on Apr. 17, 2016.

(51) Int. Cl. H04L 12/58; G06F 17/30

(52) U.S. Cl. CPC H04L 51/32; H04L 51/36; G06F 17/30876; H04L 51/34

(57) ABSTRACT

A system and method of messaging among one or more users of one or more computing devices is provided. An invitation message is being sent from a server to a first set of recipients, upon receiving such request from a sender of the invitation message, the invitation message is for participating in a group task and is associated with a pre-defined quota, the pre-defined quota being a maximum number of participants required for the group task. Then, one or more confirmation and rejection messages are received from the first set of recipients by the server, and one or more outstanding invitation messages present in one or more accounts of the first set of recipients are automatically cancelled by the server, when a number of confirmation messages received from the first set of recipients, is equal to the pre-defined quota.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### TECHNICAL FIELD

The present invention relates generally to messaging services, and more particularly to messaging services that enable the users to send invites for a group activity, and automatically rescind outstanding invites, once the conditions associated with the group activity have been met.

### BACKGROUND

Current communications technology includes Instant messaging, text messaging, SMS/MMS, email & similar among users. Electronic SMS or MMS are a great way to share lot of information instantly among users without any wastage of time. Further, these methods of sharing are cheap and cost effective.

Existing messaging platforms such as email platforms, instant messaging platforms, and social media platforms enable a sender to send an invitation message to a group of users for a group activity. Examples of the group activity include, but are not limited to, a sport event, a get-together, a movie screening, a house party, and a promotional event. The receivers may either accept or reject the invite. As soon as the sender accepts/rejects the invite, the sender receives an intimation.

However, the whole process of sending an invite for a group activity is quite cumbersome and time consuming for the sender, as he has to manually select all the recipients and send messages to them. Further, he has to keep a track of the total number of acceptances/rejections. Some estimates suggest that across all messaging platforms, the likely response rate to any mass-sent message among any user group is less than 3%. This may be due to the incorrect selection of receivers.

In order to increase the response rate, the sender may decide to send the group invite to a large number of users in his network. However, the sender may find it extremely difficult to manage the group activity, if the number of acceptances exceeds the number of users required for the activity.

Hence, there is an urgent need for a messaging platform that can overcome the limitations of existing messaging platforms, and that makes the whole process of sending group invites very efficient and easy for the sender.

### SUMMARY

In accordance with an aspect of the present invention, a method of messaging among one or more users of one or more computing devices is provided. Each computing device being provided with a messaging interface to enable corresponding user to exchange messages with other users. The method includes sending an invitation message from a server to a first set of recipients, upon receiving such request from a sender of the invitation message, the invitation message is for participating in a group task and is associated with a pre-defined quota, the pre-defined quota being a maximum number of participants required for the group task; receiving by the server, one or more confirmation and rejection messages from the first set of recipients; and automatically cancelling by the server, one or more outstanding invitation messages present in one or more accounts of the first set of recipients, when a number of confirmation messages received from the first set of recipients, is equal to the pre-defined quota.

In accordance with another aspect of the present invention, a system of messaging among one or more users is provided. The system includes one or more computing devices associated with the one or more users, and a server device communicatively coupled to the one or more computing devices through a communication network, the server providing a messaging interface on each computing device to enable corresponding user to exchange messages with other users. The server device is configured to send an invitation message to a first set of recipients, upon receiving such request from a sender of the invitation message, the invitation message is for participating in a group task and is associated with a pre-defined quota, the pre-defined quota being a maximum number of participants required for the group task; receive one or more confirmation and rejection messages from the first set of recipients; and automatically cancel one or more outstanding invitation messages present in one or more accounts of the first set of recipients, when a number of confirmation messages received from the first set of recipients, is equal to the pre-defined quota.

However, this summary is not an extensive overview of the disclosure. It is intended to neither identify key or critical elements of the disclosure, nor to delineate the scope of the present disclosure. Rather, the sole purpose of this summary is to present some concepts of the disclosure, its objects, and advantages in a simplified form as a prelude to the more detailed description that is presented hereinafter.

### BRIEF DESCRIPTION OF THE DRAWINGS

The foregoing summary, as well as the following detailed description of various embodiments, is better understood when read in conjunction with the drawings provided herein. For the purposes of illustration, there is shown in the drawings exemplary embodiments; however, the presently disclosed subject matter is not limited to the specific methods and instrumentalities disclosed.

FIG. 1 illustrates an environment, wherein various embodiments of the present invention can be practiced;

FIG. 2 illustrates in detail the messaging activity being managed by the server on the QCT/QCM platform, in accordance with an embodiment of the present invention;

FIG. 3 illustrates duplicating a task by the recipients of the task, in accordance with an embodiment of the present invention; and

FIG. 4 is a flowchart illustrating a method of messaging in the QCT/QCM platform, in accordance with an embodiment of the present invention.

### DETAILED DESCRIPTION

The presently disclosed subject matter is described with specificity to meet statutory requirements. However, the description itself is not intended to limit the scope of this patent. Rather, the inventors have contemplated that the claimed subject matter might also be embodied in other ways, to include different steps or elements similar to the ones described in this document, in conjunction with other present or future technologies.

It is to be understood that both the foregoing general description and the following detailed description are exemplary and explanatory only, and are not restrictive of the invention, as claimed. In this application, the use of the singular includes the plural, the word “a” or “an” means “at least one”, and the use of “or” means “and/or”, unless specifically stated otherwise. Furthermore, the use of the term “including”, as well as other forms, such as “includes” and “included”, is not limiting. Also, terms such as “element” or “component” encompass both elements and components comprising one unit and elements or components that comprise more than one unit unless specifically stated otherwise.

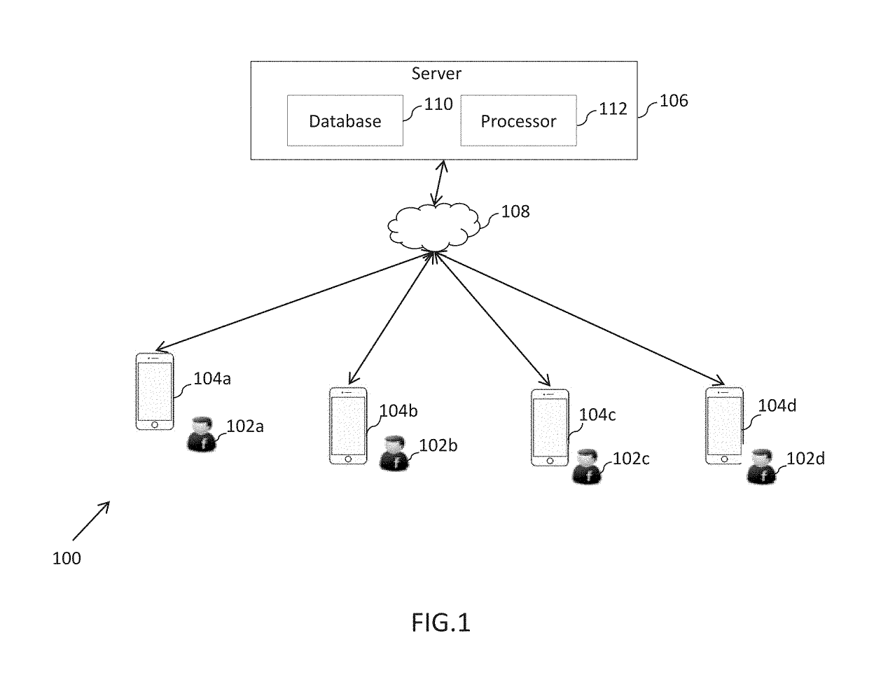

FIG. 1 illustrates an environment 100, wherein various embodiments of the present invention can be practiced.

The environment 100 includes first through fourth users 102a till 102d (hereinafter collectively referred to as users 102), first through fourth computing devices 104a till 104d (hereinafter collectively referred to as computing devices 104) associated with corresponding first through fourth users 102, and a server 106 in communication with the computing devices 104 through a communication network 108. Examples of the communication network 108 include, but are not limited to, a Local Area Network (LAN), a cellular network, a Wide Area Network (WAN), a Wi-Fi network, and any other network that provides data connectivity among the computing devices 104.

Examples of the computing devices 104 include, but are not limited to, a smart phone, a laptop, a personal digital assistant, a laptab, and a tab. Each computing device 104 may be enabled with GPS functionality to automatically know corresponding user location.

The server 106 is a web server configured to provide a Quota-cancel \messaging (QCT) platform on the computing devices 104 to enable the users 102 to exchange messages among each other. The QCM platform is implemented on the computing devices 104 through a messaging user interface that enable the users to register and login with the QCM platform, form, share and view messages.

In one of the preferred embodiments, the QCM platform enables the users 102 to form an invitation message that may contain an invite for a group activity. Examples of the group activity include, but are not limited to, a sport event, a get-together, a movie screening, a house party, and a promotional event. Examples of the invitation message type may include, but are not limited to, an instant message, an email, a Short Messaging Service (SMS) and a Multi-media Messaging Service (MMS).

In an example, a user 102 such as the first user 102a may send the invitation message to the second and third users 102b and 102c, to invite them for the group activity, and also define the steps of successfully executing that specific group activity. The group activity is also hereinafter referred to as a task, and an invitation message for the group activity is hereinafter also referred to as a task invite.

In one of the preferred embodiments, with each invitation message, a user may associate one or more pre-defined conditions, and a quota i.e. maximum number of participants required for the task with each task invite. Once the recipients receive the invitation message, they can accept/reject the task invite. In one of the preferred embodiment, the outstanding invites present in accounts of the recipients are automatically cancelled, once a predetermined quota has been met.

In one of the preferred embodiments, the server 106 may include a database 110 that stores information regarding the users 102 subscribed to the QCM platform, and a processor 112 which processes the information stored in the database 110, to manage the messaging activity among the users 102. The database 110 can be an internal and/or an external database, and may include information such as contact details, residential and office addresses, hobbies, interest, current location, list of friends, of each user 102. The database 110 may further store invitation messages shared by each user 102, quota, and responses received for each invite.

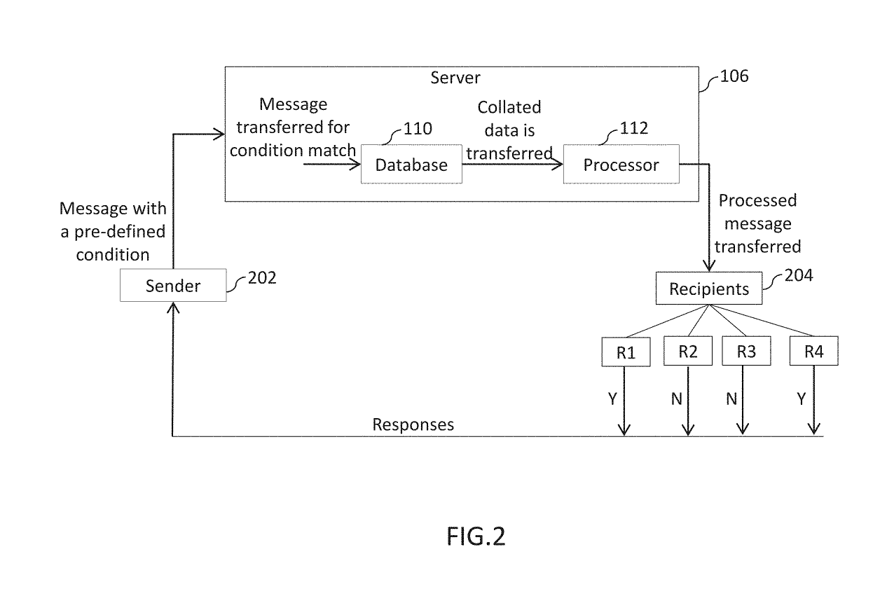

FIG. 2 illustrates in detail the messaging activity being managed by the server 106 on the QCM platform, in accordance with an embodiment of the present invention.

Among the users subscribed to the QCM platform of the server 106, one user, hereinafter referred to as a sender 202 may form an invitation message for his network of friends, and associate one or more pre-defined conditions and a quota with the invitation message. The pre-defined conditions may include, but are not limited to, ad hoc conditions, location/proximity/distance based conditions, common interests based conditions, social media membership based conditions, and relationship based conditions among users.

In one of the preferred embodiments, the QCM platform enable the sender 202 to form the invitation message based on an available list of choices including, but are not restricted to, their hobbies, likes and dislikes towards various games, cuisine choices, office and residential addresses, and the similar.

In an example, for a bowling alley game invite, the sender 202 may set a quota of nine participants, and a pre-defined condition that the invite has to be sent to those users of his network, who reside within 5 miles of the bowling alley location, or with whom they have previously gone for bowling game.

The invitation message with a pre-defined condition is received by the server 106, which is then transferred to the database 110 for a condition match. In one of the preferred embodiment, based on the information stored in the database 110, a group of recipients 204 such as R1, R2, R3 and R4 in the user network may be identified that satisfy the pre-defined condition. The processor 112 then transmits the processed message to the identified group of recipients R1, R2, R3 and R4.

For example, if 20 contacts of the sender 202 satisfy the pre-defined condition associated with the invitation message, then the invitation message may be sent to the selected 20 recipients. Once the recipients receive the invitation message, they can accept/reject the task invite. For example, the recipients R1 and R4 accept the task invite, and the recipients R2 and R3 reject the task invite. In one of the preferred embodiment, the outstanding task invites are cancelled, as soon as the maximum quota is achieved, irrespective of whether a confirmation is received or not. For example, as soon as the 9 recipients provide their confirmation to participate in the bowling alley game, 11 outstanding invites may be automatically canceled. Also, once the pre-determined quota has been achieved, the sender 202 may not accept any reply for that specific task invite.

In one of the preferred embodiments, the task invite message and details regarding corresponding responses may be saved in the database 110 for reuse by any recipient, if applicable/desired.

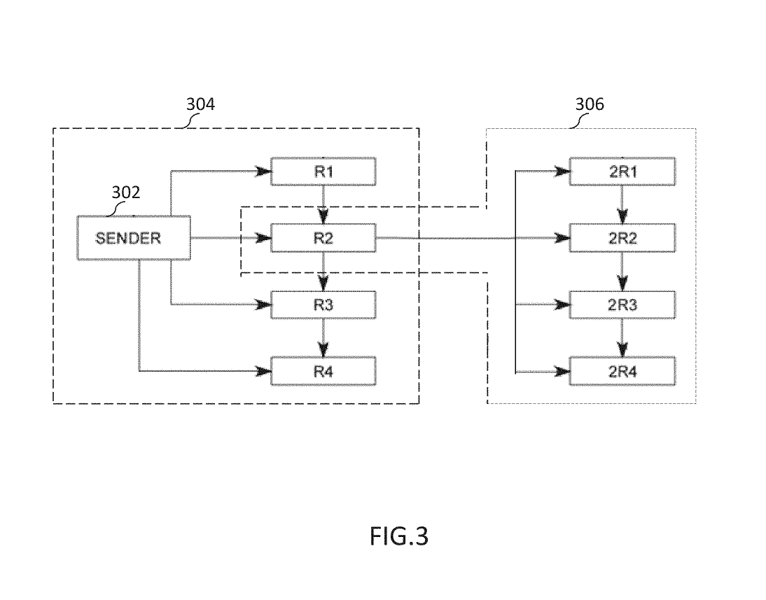

FIG. 3 illustrates duplicating a task by the recipients of the task, in accordance with an embodiment of the present invention.

In one of the preferred embodiments, a sender 302 of a first group 304 of users may determine at outset, that the recipients R1, R2, R3 and R4 of the first group 304a may forward an invitation message to a second group 306 of users (the pre-defined condition for the invitation message remaining the same as defined by the first user 102a). In such case, the recipient R2 is a sender of the second group 306, and 2R1, 2R2, 2R3 and 2R4 are the recipients of the second group 306. Thus, the recipient R2 is a common user of the first and second groups 304 and 306.

In an example, if a sender 302 sent any invitation message (which requires a team of 9 people) to 20 recipients in the first group 304, and a recipient R2 forward the invitation message to 40 recipients in the second group 306, the invitation message sent by the sender 302 may be delivered to total 60 users. As soon as any 9 recipients confirm their participation, all outstanding invites (which are now 51) would be automatically cancelled.

In one of the preferred embodiments, there can be only one sender for one task in a group of users, for example, there can be only one sender 302 in the first group 304, and there can be only one sender, i.e. the recipient R2 in the second group 306. Further, the sender 302 cannot be the recipient for the relay of the particular task that is initiated by the sender 302 in the first group 304.

In one of the preferred embodiments, if a quota has been achieved for the sender 302, and he would not accept further rejections/acceptances, then a subsequent user such as recipient R3 may choose to become a new sender. The new sender R3 may (or may not) choose to vary the conditions of the original message, and thus a new set of recipients is formed for the new sender based on the pre-defined conditions. The entire process explained with reference to FIG. 2 is replicated for the new sender R3, and the replica becomes ‘property’ of the new sender R3, which means that the new sender R3 now becomes a new host/organizer of the task.

In one of the preferred embodiments, the recipient R3 might not have achieved the quota, perhaps were too late or might choose to take the original invitation and invites his or her own contacts, thus repeating the original action and with the same rules features and constraints. Thus perpetuating and/or duplicating the original action for deciding the recipients of the task message, define a quota.

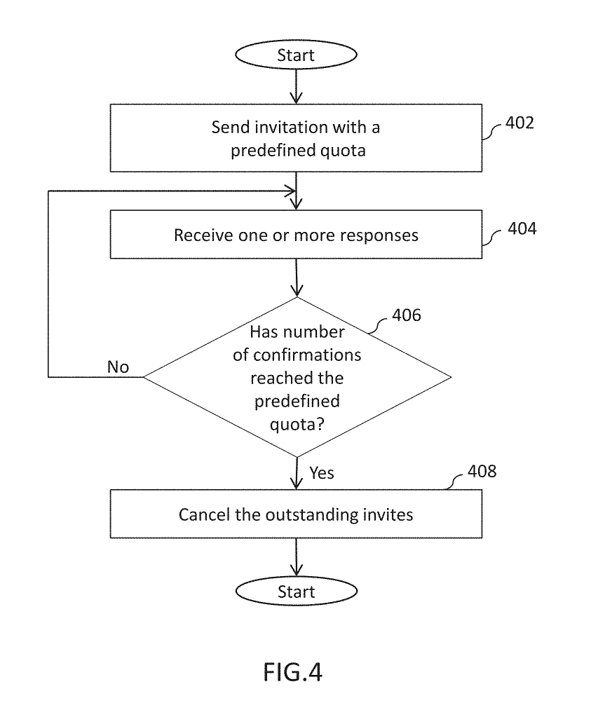

FIG. 4 is a flowchart illustrating a method of messaging in the QCM platform, in accordance with an embodiment of the present invention.

At step 402, a sender may send an invitation message for a task/activity to a group of users, where the invitation message may be associated with a pre-defined condition, and a predefined quota. The invitation message may also include the steps of successfully executing the task.

At step 404, the sender receives one or more responses from the recipients. Once the recipients receive the task invite, they can accept/reject the task invite.

At step 406, it is checked if the number of confirmation messages from the recipients has reached the predefined quota. In an example, the number of recipients may be 20, and the predefined quota may be 9, and it is checked if 9 participants have provided their confirmations for the task.

At step 408, all the outstanding invitation messages are canceled when the number of confirmations has reached the predefined quota. In an example, as soon as the number of confirmations is equal to 9, the 11 outstanding invites are automatically cancelled.

The QCM platform is designed so that users may define their own individual uses of the technology, but the structure of QCM is integral to these diverse iterations. The QCM platform addresses the challenge with a simple solution: it imposes a simple ‘first past the post’ (FPTP) qualification of quota, followed by cancellation of all outstanding task invitations. The FPTP incentivizes a shorter response time and introduces competition resulting into competition which raises response rate and attentiveness to task. The FPTP is followed by cancellation of all outstanding tasks which reduces the burden of response to the sender.

The QCM platform may be implemented in various fields. For example a business owner may send request(s) to staff to fill vacant gaps, or send location/time/quota based tasks/offers to the business's community to enhance/generate trade. In a business organization, the QCM platform offers following advantages:
a. Speeds up satisfaction of a quota;
b. Saves further time by reducing communication burden beyond satisfaction of quota;
c. Over time generates useful metrics by scoring responses, which further enhance initiators capacity to choose assignees efficiently/effectively;
d. Stimulates the facilitation/execution of tasks by introducing immediate competition (FPTP), followed by ongoing competition (in the form of the display of generated metrics and attendant bragging rights);
e. Assists in planning and execution of events, especially ‘group events’;
f. Duplication further enhances the social reach of the initial task.

Embodiments described herein relate to the field of communication system via mobile devices. More particularly the embodiments relate to the electronic SMS or MMS messaging services that can define an actions/planning/tasks/status updates/thread or post on social media (or similar) (hereafter ‘task’ for short) and can automatically rescinds superfluous invitations once the conditions associated with the task have been met/achieved/completed among the user messaging group.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples.

What is claimed is:

1. A method of messaging among one or more users of one or more computing devices, each computing device being provided with a messaging interface to enable corresponding user to exchange messages with other users, the method comprising:
sending an invitation message from a server to a first set of recipients, upon receiving such request from a sender of the invitation message, the invitation message is for participating in a group task and is associated with a pre-defined quota, the pre-defined quota being a maximum number of participants required for the group task;
receiving by the server, one or more confirmation and rejection messages from the first set of recipients; and
automatically cancelling by the server, one or more outstanding invitation messages present in one or more accounts of the first set of recipients, when a number of confirmation messages received from the first set of recipients, is equal to the pre-defined quota.

2. The method as claimed in claim 1 further comprising:
receiving the invitation message at the server from the sender, the invitation message being associated with one or more pre-defined conditions;
determining by the server, the first set of recipients based on the one or more pre-defined conditions; and
sending the invitation message from the server to the first set of recipients.

3. The method as claimed in claim 2 further comprising:
forwarding the invitation message from a recipient of the first set of recipients, to a second set of recipients, the second set of recipients being determined by the server based on the one or more predefined conditions upon receiving such request from the recipient;
receiving one or more confirmation and rejection messages from the first and the second set of recipients; and
automatically cancelling one or more outstanding message invitations present in one or more accounts of the first and second set of recipients, when a number of confirmation messages received from the first and the second set of recipients, is equal to the pre-defined quota.

4. The method as claimed in claim 3, wherein the sender is configured to not to receive the invitation message from the first and the second set of recipients.

5. The method as claimed in claim 2 further comprising:
determining a new set of recipients by the server device for sending the invitation message, upon receiving such request from a recipient of the first set of recipients, wherein the request is generated by such recipient when the pre-defined quota has been met for the sender, and wherein the request is associated with one or more new predefined conditions and a new predefined quota;
sending the invitation message to the new set of recipients;
receiving one or more confirmation and rejection messages from the new set of recipients; and
automatically cancelling one or more outstanding invitation messages in one or more accounts of the new set of recipients, when a number of confirmation messages received from the new set of recipients is equal to the new pre-defined quota.

6. The method as claimed in claim 2, wherein the one or more pre-defined conditions are based on one or more distances between one or more users, common interests of the one or more users, social media membership of the one or more users, relationship among the one or more users, and location of the one or more users.

7. The method as claimed in claim 3, wherein the server refers a database for determining the first and the second set of recipients, and for each user, the database store contact details, residential and office addresses, hobbies, interest, current location, list of friends, details of invitation messages sent, and responses sent by the user.

8. The method as claimed in claim 1, wherein the invitation message is at least one of: an instant message, an email, a Short Messaging Service (SMS) and a Multi-media Messaging Service (MMS).

9. The method as claimed in claim 1, wherein the one or more users are users of a social network.

10. A system of messaging among one or more users, the system comprising:
one or more computing devices associated with the one or more users; and
a server device communicatively coupled to the one or more computing devices through a communication network, the server providing a messaging interface on each computing device to enable corresponding user to exchange messages with other users, wherein the server device is configured to:
send an invitation message to a first set of recipients, upon receiving such request from a sender of the invitation message, the invitation message is for participating in a group task and is associated with a pre-defined quota, the pre-defined quota being a maximum number of participants required for the group task;
receive one or more confirmation and rejection messages from the first set of recipients; and
automatically cancel one or more outstanding invitation messages present in one or more accounts of the first set of recipients, when a number of confirmation messages received from the first set of recipients, is equal to the pre-defined quota.

11. The system as claimed in claim 10, wherein the server device is further configured to:
receive the invitation message from the sender, the invitation message being associated with one or more pre-defined conditions;
determine the first set of recipients based on the one or more pre-defined conditions; and
send the invitation message to the first set of recipients.

12. The system as claimed in claim 11, wherein the server device is further configured to:
forward the invitation message from a recipient of the first set of recipients, to a second set of recipients, the second set of recipients being determined by the server device based on the one or more predefined conditions, upon receiving such request from the recipient;
receive one or more confirmation and rejection messages from the second set of recipients; and
automatically cancel one or more outstanding message invitations present in one or more accounts of the first and second set of recipients, when a number of confirmation messages received from the first and the second set of recipients, is equal to the pre-defined quota.

13. The system as claimed in claim 11, wherein the sender is configured to not to receive the invitation message from the first and the second set of recipients.

14. The system as claimed in claim 11, wherein the server device is further configured to:
determine a new set of recipients by the server device for sending the invitation message, upon receiving such request from a recipient of the first set of recipients, wherein the request is generated by such recipient when the pre-defined quota has been met for the sender, and wherein the request is associated with one or more new predefined conditions and a new predefined quota;
send the invitation message to the new set of recipients;
receive one or more confirmation and rejection messages from the second set of recipients; and
automatically cancel one or more outstanding invitation messages in one or more accounts of the new set of recipients, when a number of confirmation messages received from the new set of recipients is equal to the new pre-defined quota.

15. The system as claimed in claim 11, wherein the one or more predefined conditions are based on one or more distances between one or more users, common interests of the one or more users, social media membership of the one or more users, relationship among the one or more users, and location of the one or more users.

16. The system as claimed in claim 11, wherein the server comprises:
a database configured to store contact details, residential and office addresses, hobbies, interest, current location, list of friends, invitation messages, and responses of the one or more users; and
a processor configured to determine the first and the second set of recipients based on the information stored in the database.

17. The system as claimed in claim 10, wherein the invitation message is at least one of: an instant message, an email, a Short Messaging Service (SMS) and a Multi-media Messaging Service (MMS).

18. The system as claimed in claim 10, wherein the one or more users are users of a social network.

19. The system as claimed in claim 10, wherein the computing device is selected from at least one of: a mobile phone, a satellite phone, a tablet, and a laptop.
